(19) United States
(12) Patent Application Publication
(10) Pub. No.: US 2013/0121422 A1
(43) Pub. Date: May 16, 2013

(54) Method And Apparatus For Encoding/Decoding Data For Motion Detection In A Communication System

(71) Applicants: Hong Jiang, Warren, NJ (US); Raziel Haimi-Cohen, Springfield, NJ (US); Paul A. Wilford, Bernardsville, NJ (US)

(72) Inventors: Hong Jiang, Warren, NJ (US); Raziel Haimi-Cohen, Springfield, NJ (US); Paul A. Wilford, Bernardsville, NJ (US)

(73) Assignee: ALCATEL-LUCENT USA INC., Murray Hill, NJ (US)

(21) Appl. No.: 13/296,482

(22) Filed: Nov. 15, 2011

(51) Int. Cl. H04N 7/26

(52) U.S. Cl. 375/240.26; 375/E07.2

(57) ABSTRACT

Embodiments relate to an apparatus and method for encoding/decoding data for motion detection in a communication system. The method for encoding data includes receiving, by an encoder, video data including a plurality of frames. Each frame is represented by a pixel vector including a number of pixel values. The method further includes generating, by the encoder, sets of measurements representing the plurality of frames. Each set of measurements represents a different frame of the plurality of frames. The generating step generates the sets of measurements by applying sensing matrices to the pixel vectors, and a same sensing matrix is used for at least two sets of measurements.

### BACKGROUND

Conventional surveillance systems involve a relatively large amount of video data stemming from the amount of time monitoring a particular place or location and the number of cameras used in the surveillance system. However, among the vast amounts of captured video data, the detection of anomalies/foreign objects is of prime interest. As such, there may be a relatively large amount of video data that will be unused.

In most conventional surveillance systems, the video from a camera is not encoded. As a result, these conventional systems have a large bandwidth requirement, as well as high power consumption for wireless cameras. In other types of conventional surveillance systems, the video from a camera is encoded using Motion JPEG, MPEG/H.264. However, this type of encoding involves high complexity and/or high power consumption for wireless cameras. Further, Motion JPEG, MPEG/H.264 encoding includes a relatively high bit rate for the detection of anomalies.

### SUMMARY

Embodiments relate to a method and apparatus for encoding/decoding data for motion detection in a communication system.

The method for encoding data includes receiving, by an encoder, video data including a plurality of frames. Each frame is represented by a pixel vector including a number of pixel values. The method further includes generating, by the encoder, sets of measurements representing the plurality of frames. Each set of measurements represents a different frame of the plurality of frames. The generating step generates the sets of measurements by applying sensing matrices to the pixel vectors, and a same sensing matrix is used for at least two sets of measurements.

In one embodiment, the sets of measurements include pairs of sets of measurements, and each pair includes a first set of measurements representing a first frame and a second set of measurements representing a second frame. For each pair, the generating step generates the first set of measurements and the second set of measurements using a same sensing matrix, and different sensing matrices are used for at least two pairs. The first frame and the second frame may be consecutive frames in the plurality of frames.

In one embodiment, the generating step generates groups of sets of measurements by applying sensing matrices to pixel vectors. Each group includes at least two sets of measurements, where a same sensing matrix is used to generate each set of measurement in the same group, and the sensing matrices used in at least two groups are different.

The method for detecting at least one moving objection includes receiving, by a decoder, sets of measurements. Each set of measurements represents a different frame of video data. The method further includes obtaining, by the decoder, inter-frame difference among the sets of measurements, and detecting, by the decoder, the at least one moving object in the video data by processing the inter-frame difference between the sets of measurements.

In one embodiment, the receiving step receives a pair of measurements. The pair includes a first set of measurements representing a first frame of video data and a second set of measurements representing a second frame of video data. The obtaining step obtains the difference between the first set of measurements and the second set of measurements as the inter-frame difference.

The method may further include computing, by the decoder, a criterion value based on the inter-frame difference among the sets of measurements, and detecting the at least one moving object in the video data if the criterion value is above a first threshold.

Also, the method may include obtaining, by the decoder, a sensing matrix that was applied to pixel vectors representing the frames at an encoder. The sensing matrix has the same assigned values for each of the frames. The method further includes reconstructing, by the decoder, the inter-frame difference among the frames based on the obtained inter-frame difference among the sets of measurements and the sensing matrix, and detecting the at least one moving object if at least one pixel in the reconstructed difference among the frames have a magnitude above a second threshold.

In one embodiment, at least one moving object is extracted by identifying contiguous regions of pixels in the reconstructed difference which have a magnitude above the second threshold.

The method may further include obtaining, by the decoder, groups of sets of measurements for frames in the video data over a period of time, and obtaining, by the decoder, sensing matrices that were applied to pixel vectors representing the frames at the encoder. Each group corresponds to a different sensing matrix. The method further includes reconstructing, by the decoder, pixel values for a scene that is common to each group and a pixel difference value for each group based on the groups of measurements and the obtained sensing matrices. The reconstructed pixel values for the scene that is common to each group is background of the video data. The method further includes detecting the at least one moving object based on the reconstructed pixel values and the pixel difference value for each pair.

In one embodiment, the method includes displaying the video data based on the reconstructed pixel values and the pixel difference value for each group, and detecting the at least one moving object based on displayed video data.

The embodiments include an apparatus for encoding data in a communication system. The apparatus includes an encoder configured to receive video data including a plurality of frames. Each frame is represented by a pixel vector including a number of pixel values. The encoder is configured to generate sets of measurements representing the plurality of frames. Each set of measurements represents a different frame of the plurality of frames. The encoder generates the sets of measurements by applying sensing matrices to the pixel vectors, and a same sensing matrix is used for at least two sets of measurements.

In one embodiment, the sets of measurements include pairs of sets of measurements. each pair includes a first set of measurements representing a first frame and a second set of measurements representing a second frame. For each pair, the encoder is configured to generate the first set of measurements and the second set of measurements using a same sensing matrix, and different sensing matrices are used for at least two pairs.

The embodiments include an apparatus for detecting at least one moving object in a communication system. The apparatus includes a decoder configured to receive sets of measurements. Each set of measurements represents a different frame of video data. The decoder is configured to obtain inter-frame difference among the sets of measurements. The decoder configured to detect the at least one moving object in the video data by processing the inter-frame difference between the sets of measurements.

In one embodiment, the decoder is configured to receive a pair of measurements. The pair includes a first set of measurements representing a first frame of video data and a second set of measurements representing a second frame of video data. The decoder is configured to obtain the difference between the first set of measurements and the second set of measurements as the inter-frame difference.

Also, the decoder is configured to compute a criterion value based on the inter-frame difference among the sets of measurements. The decoder is configured to detect the at least one moving object in the video data if the criterion value is above a first threshold.

In another embodiment, the decoder is configured to obtain a sensing matrix that was applied to pixel vectors representing the frames at an encoder. The sensing matrix has the same assigned values for each of the frames. The decoder is configured to reconstruct the inter-frame difference among the frames based on the obtained inter-frame difference among the sets of measurements and the sensing matrix. The decoder is configured to detect the at least one moving object if at least one pixel in the reconstructed difference among the frames have a magnitude above a second threshold.

Also, the decoder is configured to obtain groups of sets of measurements for frames in the video data over a period of time. The decoder is configured to obtain sensing matrices that were applied to pixel vectors representing the frames at the encoder. Each group corresponds to a different sensing matrix. The decoder is configured to reconstruct pixel values for a scene that is common to each group and a pixel difference value for each group based on the groups of measurements and the obtained sensing matrices. The reconstructed pixel values for the scene that is common to each group being background of the video data. The at least one moving object is detected based on the reconstructed pixel values and the pixel difference value for each pair.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 illustrates a communication network according to an embodiment;

FIG. 2 illustrates components of a camera assembly and a processing unit according to an embodiment;

FIG. 3 illustrates a graphical representation of an encoding scheme using compressive sensing according to an embodiment;

FIG. 4 illustrates a method of detecting moving objects in the communication system according to an embodiment;

FIG. 5 illustrates a method of detecting moving objects in the communication system according to an embodiment; and

FIG. 6 illustrates a method of detecting motion of an object in the communication system according to another embodiment.

### DETAILED DESCRIPTION OF EXAMPLE EMBODIMENTS

Various embodiments of the present disclosure will now be described more fully with reference to the accompanying drawings. Like elements on the drawings are labeled by like reference numerals.

As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The embodiments will now be described with reference to the attached figures. Various structures, systems and devices are schematically depicted in the drawings for purposes of explanation only and so as not to obscure the present disclosure with details that are well known to those skilled in the art. Nevertheless, the attached drawings are included to describe and explain illustrative examples of the embodiments. The words and phrases used herein should be understood and interpreted to have a meaning consistent with the understanding of those words and phrases by those skilled in the relevant art. To the extent that a term or phrase is intended to have a special meaning, i.e., a meaning other than that understood by skilled artisans, such a special definition will be expressly set forth in the specification that directly and unequivocally provides the special definition for the term or phrase.

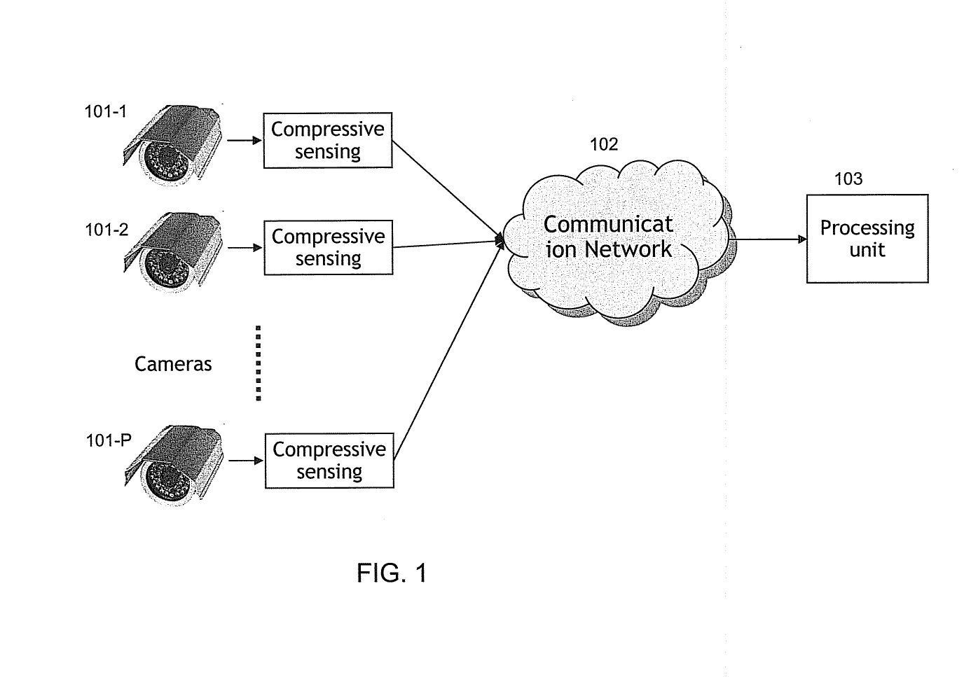

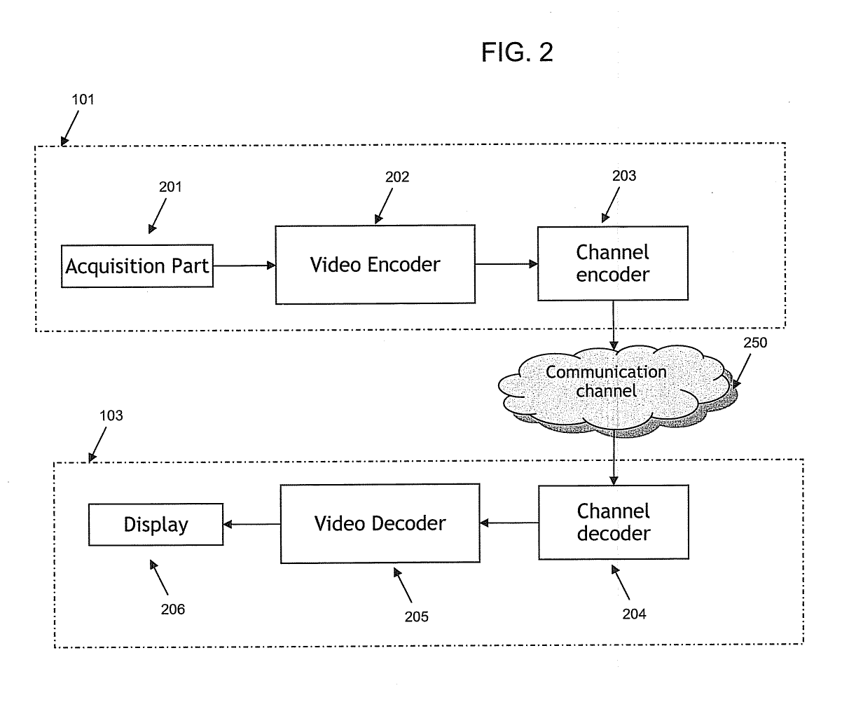

The embodiments include a method and apparatus for encoding/decoding video data in a communication network. The overall network is further explained below with reference to FIG. 1. In one embodiment, the communication network may be a surveillance network. The communication network may include a camera assembly that encodes video data using compressive sensing, and transmits sets of measurements that represent the acquired video data. The camera assembly may be stationary or movable and it may be operated continuously or in brief intervals which may be pre-scheduled or initiated on demand. Further, the communication network may include a processing unit that decodes the sets of measurements and detects motion of at least one object within the acquired video data. The details of the camera assembly and the processing unit are further explained with reference to FIG. 2.

The video data includes a sequence of frames, where each frame may be represented by a pixel vector having N pixel values. The camera assembly computes a set of M measurements Y (e.g., Y is a vector containing M values) for each frame by applying a sensing matrix (also known as a measurement matrix) to a frame of the video data, where M is less than N. The sensing matrix is a type of matrix having dimension M×N. In other words, the camera assembly generates sets of measurements (each set corresponding to a frame of video data) by applying the sensing matrices to the pixel vectors of the video data.

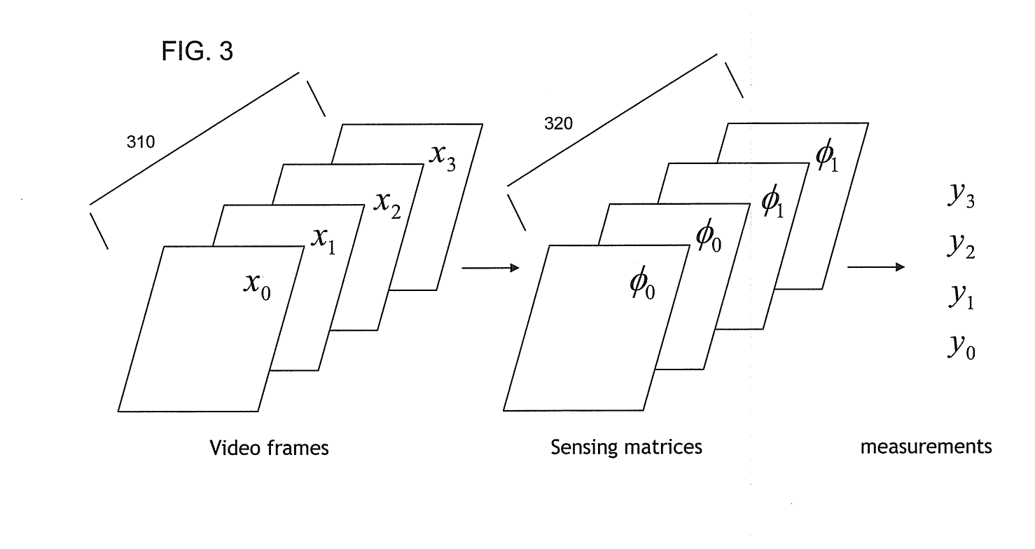

According to one embodiment, the same sensing matrix is applied to at least two pixel vectors representing a first frame and a second frame. However, the embodiments encompass the situation where the same sensing matrix is applied to two or more pixel vectors. As a result, the camera assembly generates pairs of measurements, where each pair includes a first set of measurements and a second set of measurements corresponding to the first frame and the second frame, respectively. Also, if the same sensing matrix is applied to more than two pixel vectors, the camera assembly generates groups of measurements, where the same sensing matrix is applied to each set of measurements in the group. The first frame and the second frame may be consecutive frames. Also, the sensing matrix may be different from pair to pair, or from group to group. In one embodiment, the camera assembly may directly compute the compressive measurements without first capturing the frames pixel by pixel, as further described in application Ser. No. 12/894,855 filed Sep. 30, 2010, which is incorporated herein by reference in its entirety. In yet another embodiment, the camera may be moveable, e.g. panned to different directions, or operated only for short intervals, and each group of measurements obtained with the same matrix is associated with a particular camera position or particular operation interval. Then, the camera assembly transmits the sets of measurements to another device for further processing. These encoding techniques are further explained with reference to FIG. 3.

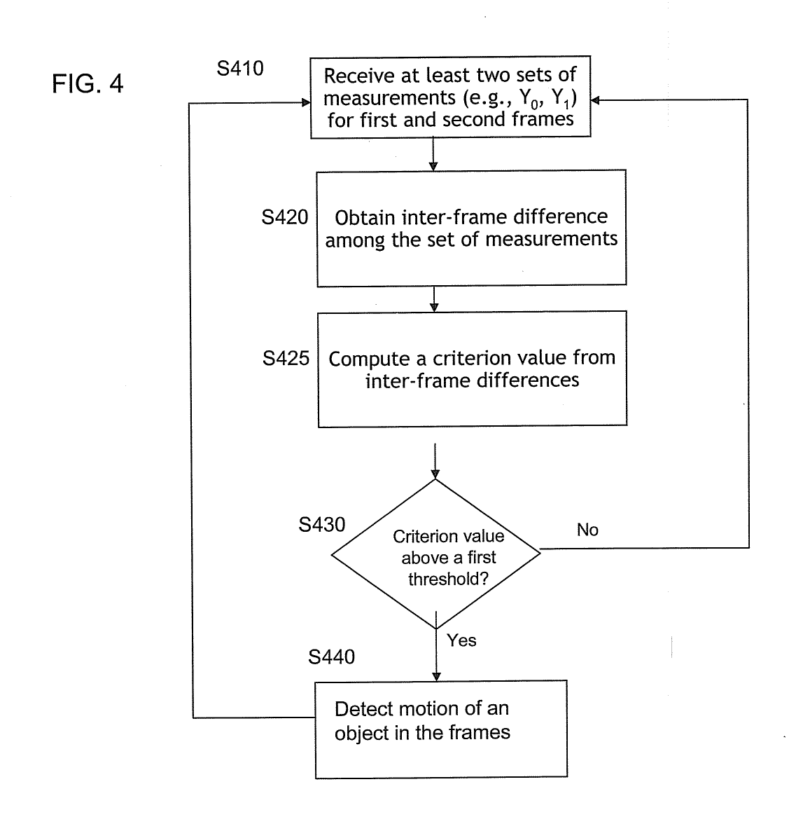

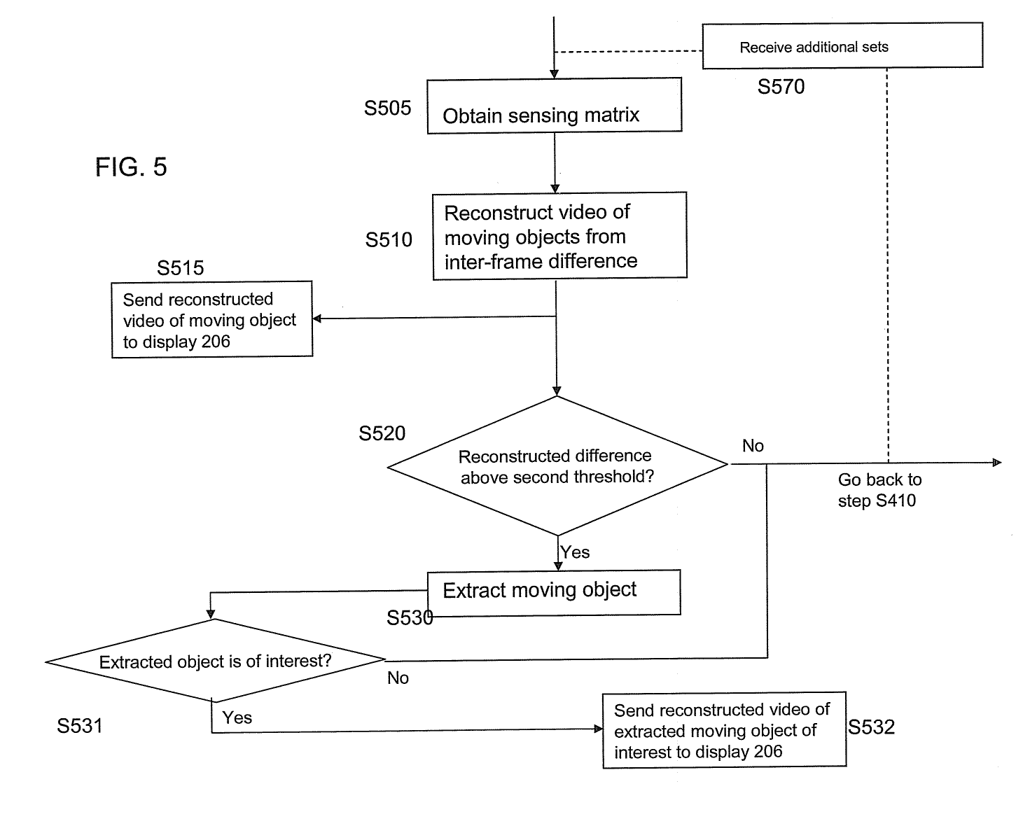

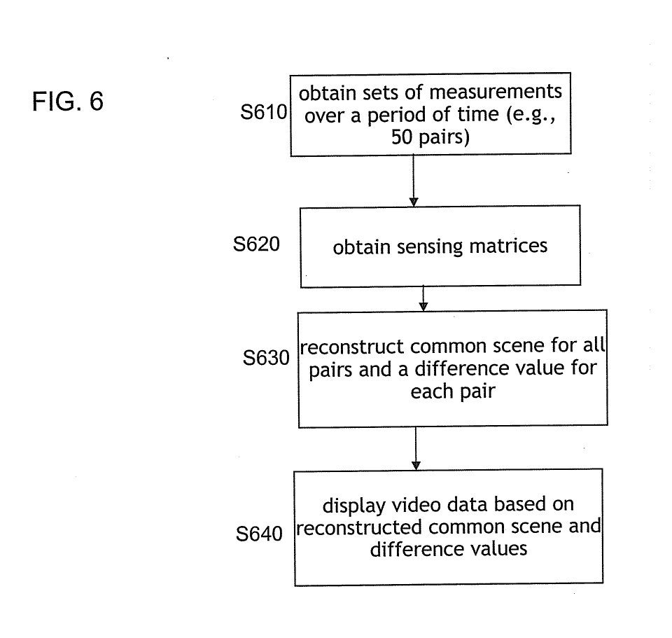

After receiving the sets of measurements (e.g., two or more sets of measurements that were generated from the same sensing matrix), the processing unit may obtain inter-frame difference between the sets of measurements, and then detect motion of an object in the video data by further processing the inter-frame difference between the sets of measurements. In one embodiment, the processing unit detects motion of an object if a criterion value computed from the inter-frame difference among the sets of measurements is above a first threshold. These features are further explained with reference to FIG. 4. Also, the processing unit may detect motion objects based on the methods described in FIGS. 5-6, which may be an extension of FIG. 4, or a separate motion detection method.

FIG. 1 illustrates a communication network according to an embodiment. In one embodiment, the communication network may be a surveillance network. The communication network includes one or more camera assemblies 101 for acquiring, encoding and/or transmitting data such as video, audio and/or image data, a surveillance network 102, and at least one processing unit 103 for receiving, decoding and/or displaying the received data. The camera assemblies 101 may include one camera assembly or a first camera assembly 101-1 to P camera assembly 101-P, where P is any integer greater or equal to two. The communication network 102 may be any known transmission, wireless or wired, network. For example, the communication network 102 may be a wireless network which includes a radio network controller (RNC), a base station (BS), or any other known component necessary for the transmission of data over the communication network 102 from one device to another device.

The camera assembly 101 may be any type of device capable of acquiring data and encoding the data for transmission via the communication network 102. Each camera assembly device 101 includes a camera for acquiring video data, at least one processor, a memory, and an application storing instructions to be carried out by the processor. The acquisition, encoding, transmitting or any other function of the camera assembly 101 may be controlled by at least one processor. However, a number of separate processors may be provided to control a specific type of function or a number of functions of the camera assembly 101. The implementation of the controller(s) to perform the functions described below is within the skill of someone with ordinary skill in the art.

The processing unit 103 may be any type of device capable of receiving, decoding and/or displaying data such as a personal computer system, mobile video phone, smart phones or any type of computing device that may receive data from the communication network 102. The receiving, decoding, and displaying or any other function of the processing unit 103 may be controlled by at least one processor. However, a number of separate processors may be provided to control a specific type of function or a number of functions of the processing unit 103. The implementation of the controller(s) to perform the functions described below is within the skill of someone with ordinary skill in the art.

FIG. 2 illustrates functional components of the camera assembly 101 and the processing unit 103 according to an embodiment. For example, the camera assembly 101 includes an acquisition part 201, a video encoder 202, and a channel encoder 203. In addition, the camera assembly 101 may include other components that are well known to one of ordinary skill in the art. Referring to FIG. 2, in the case of video, the acquisition part 201 may acquire data from the video camera component included in the camera assembly 101 or connected to the camera assembly 101. The acquisition of data (video, audio and/or image) may be accomplished according to any well known methods. Although the below descriptions describes the encoding and decoding of video data, it is understanding that similar methods may be used for image data or audio data, or any other type of data that may be represented by a set of values.

The video encoder 202 encodes the acquired data using compressive sensing to generate sets of measurements to be stored on a computer-readable medium such as an optical disk or internal storage unit or to be transmitted to the processing unit 103 via the communication network 102. The encoding of video data is further explained with reference to FIG. 3. It is also possible to combine the functionality of the acquisition part 201 and the video encoder 202 into one unit, as described in co-pending application Ser. No. 12/894,855. Also, it is noted that the acquisition part 201, the video encoder 202 and the channel encoder 203 may be implemented in one, two or any number of units.

Using the sets of measurements, the channel encoder 203 codes or packetizes the measurements to be transmitted over the communication network 102. For example, the set of measurements may be processed to include parity bits for error protection, as is well known in the art, before they are transmitted or stored. Then, the channel encoder 203 may then transmit the coded sets of measurements to the processing unit 103 or store them in a storage unit.

The processing unit 103 includes a channel decoder 204, a video decoder 205, and optionally a video display 206. The processing unit 103 may include other components that are well known to one of ordinary skill in the art. The channel decoder 204 decodes the sets of measurements received from the communication network 102. For example, each set of measurements is processed to detect and/or correct errors from the transmission by using the parity bits of the data. The correctly received packets are unpacketized to produce the quantized measurements generated in the video encoder 202. It is well known in the art that data can be packetized and coded in such a way that a received packet at the channel decoder 204 can be decoded, and after decoding the packet can be either corrected, free of transmission error, or the packet can be found to contain transmission errors that cannot be corrected, in which case the packet is considered to be lost. In other words, the channel decoder 204 is able to process a received packet to attempt to correct errors in the packet, to determine whether or not the processed packet has errors, and to forward only the correct measurements information from an error free packet to the video decoder 205.

The video decoder 205 receives the sets of correctly received measurements and determines whether motion is detected in the video data. The video decoder 205 may receive transmitted sets of measurements or receive sets of measurements that have been stored on a computer readable medium such as an optical disc or storage unit. Further, the video decoder 205 reconstructs the data for the sets of correctly received measurements. For example, the video decoder 205 obtains information indicating the sensing matrices, which were applied at the video encoder 202 and performs an optimization process on the sets of measurements using the specified sensing matrices. The details of the video decoder 205 are further explained with reference to FIGS. 4-6.

The display 206 may be a video display screen of a particular size, for example. The display 206 may be included in the processing 103, or may be connected (wirelessly, wired) to the processing unit 103. The processing unit 103 displays the decoded video data on the display 206 of the processing unit 103. Also, it is noted that the display 206, the video decoder 205 and the channel decoder 204 may be implemented in one or any number of units. Furthermore, instead of the display 206, the processed data may be sent to another processing unit for further analysis, such as, determining whether the objects are persons, cars, etc.

FIG. 3 illustrates a graphical representation of an encoding scheme using compressive sensing according to an embodiment.

The video encoder 202 receives the acquired video data from the acquisition part 201. The video data includes a sequence of frames 310 (e.g., x₀, x₁, x₂, x₃), where each frame is represented by a pixel vector having N pixel values. The video encoder 202 generates a plurality of sensing matrices 320 (e.g., φ₀, φ₁). The sensing matrices 320 may be previously known by the video encoder 202, and thus may obtain the sensing matrices 320 from an internal memory of the camera assembly 101, or generated at run time according to a predefined formula.

The video encoder 202 applies the plurality of sensing matrices 320 (e.g., φ₀, φ₁) to the pixel vectors corresponding to the sequence of frames 310. Each sensing matrix has a dimension of M×N. The sensing matrices may be a random matrix, a Walsh-Hadamard matrix, or a matrix whose rows are shifted maximum length sequences (m-sequences) as described in application Ser. No. 13/213,743 filed on Aug. 19, 2011, which is incorporated by reference in its entirety.

As shown in FIG. 3, the video encoder 202 computes sets of measurements y₃, y₂, y₁, y₀, where each set of measurements is a vector of length M, where M is less than N. For example, the video encoder 202 computes a particular set of measurements (e.g., y₀) for a frame (e.g., x₀) of video data by applying a sensing matrix (e.g., φ₀) to the frame (e.g., x₀) of video data.

The video encoder 202 computes the sets of measurements as follows:

y₂ₖ=φₖx₂ₖ

y₂ₖ₊₁=φₖx₂ₖ₊₁ Eq. 1:
k=0, 1, 2, . . . .

The parameter y is the set of measurements, x is the pixel vector having a number of pixel values for the frame, and k is any integer greater than or equal to zero, and φ is the sensing matrix as previously described. As this equation illustrates, the measurements are made for each pair of frames. For instance, the same sensing matrix is used for each of the frames in a pair, but the sensing matrices are different from pair to pair.

In one particular example, (e.g., when k=0), the video encoder 202 multiples the sensing matrix φ₀ (of dimension M×N) by the vector x₀ (e.g., the values of the pixels for the first frame) to obtain a set of measurements y₀ having M values. The video encoder 202 applies the same sensing matrix φ₀ to the subsequent frame (e.g., x₁). For instance, the video encoder 202 multiples the sensing matrix φ₀ (of dimension M×N) by the vector x₁ (e.g., the values of the pixels for the second frame) to obtain a set of measurements y₁ having M values. In other words, measurements are made for each pair of frames. As such, the same sensing matrix is used for each of the frames in a pair, but the matrices are different from pair to pair. As shown in FIG. 3, the sensing matrix φ₀ is used for frames x₀ and x₁, and sensing matrix φ₁ is used for frames x₂ and x₃. The sensing matrix φ₁ is different than the sending matrix φ₀.

In addition to the application of the sensing matrix, the computation of the sets of measurements may include other processing steps, such as preprocessing (e.g. by filtering) the video before applying the sensing matrices or scaling and quantization of the computed measurement values. These processing steps are well known to those skilled in the art and are not described here explicitly.

Although the same sensing matrix is described to be used for two consecutive frames, embodiments of the present invention encompass using the same sensing matrix for any number of frames. Furthermore, the same sensing matrix does not necessarily have to be used for consecutive frames. For example, the same sensing matrix could be applied for each odd/even pair of frames.

Referring back to FIG. 2, using the sets of measurements, the channel encoder 203 packetizes or codes the measurements to be transmitted over the communication network 102. For example, the channel encoder 203 performs variable length coding of the measurements after the distribution of the values of the measurements are known, by applying coding techniques such as Huffman coding or arithmetic coding. These techniques assign fewer bits to statistically frequent values and thus reduce the data rate, bringing it closer to the entropy rate. The channel encoder 203 may then transmit the encoded sets of measurements to the processing unit 103 or store them in a storage unit.

The channel decoder 204 decodes the received sets of encoded measurements in order to obtain correctly received measurements, as previously described above. The channel decoder 205 forwards the correctly received sets of measurements and the other information to the video decoder 205 so that the video decoder 205 can reconstruct the video data, as further explained below.

FIG. 4 illustrates a method of detecting moving objects in the communication system according to an embodiment.

In step S410, the video decoder 205 receives at least two sets of measurements (e.g., Y₀, Y₁). The at least two sets of measurements includes a first set of measurements representing a first frame and a second set of measurements representing a second frame, where the second frame may follow the first frame. The first set of measurements and the second set of measurements have been previously encoded using the same sensing matrix, as described above. Also, the video decoder 205 may receive more than two sets of measurements that have been encoded using the same sensing matrix. As previously described, each set of measurements may be considered a vector having M measurements.

In step S420, the video decoder 205 obtains an inter-frame difference between the sets of received measurements. The inter-frame difference is a set of values associated with corresponding measurements in each of the sets of received measurements. Equivalently, each value in the inter-frame difference corresponds to one row in the common sensing matrix. For the case that two sets of measurements have been generated using the same sensing matrix, the video decoder 205 obtains a difference between the first set of measurements representing the first frame and the second set of measurements representing the second frame. In other words, the video decoder 205 computes the difference by subtracting the first set of measurements from the second set of measurements, or vice versa. If more than two sets of measurements have been generated using the same sensing matrix, the video decoder 205 obtains an estimate of the inter-frame difference. For example, the video decoder 205 may obtain the inter-frame difference using linear regression. Suppose that measurements yₙ₍₁₎, . . . , yₙ₍ₖ₎ were obtained from frames xₙ₍₁₎, . . . , xₙ₍ₖ₎, where n(k), k=1, . . . , K is the sequential index of the k-th frame (those indices may not be consecutive). Using well known techniques of linear regression, the video decoder 205 computes a linear approximation to the measurements yₖ in the faun of y′ₖ=c+Δn(k). Here, the parameter c represents the constant part of the measurements and the parameter Δ is the estimated inter-frame difference between measurements of consecutive frames.

In step S425, the video decoder 205 computes a criterion value from the values of the inter-frame difference. Such a criterion value may be, for example, the maximum magnitude, the average or median of magnitudes or the root mean of squares (RMS) of the values of the inter-frame difference. These values may be further normalized by dividing by the average magnitude or RMS of the measurements in the sets of measurements from which the difference was computed.

In step S430, the video decoder 205 determines whether the criterion value calculated in step S425 is above a first threshold. If the video decoder 205 determines that the criterion value is equal to or less than the first threshold, the process returns to step S410 in order to receive additional sets of measurements (e.g., a pair of measurements). However, if the video decoder 205 determines that the criterion value is above the first threshold, in step S440, the video decoder 205 detects the existence of moving objects. For example, the video decoder 205 may detect the presence of moving objects, and then transmit information indicating that motion of a particular object has been detected.

FIG. 5 illustrates a method of detecting moving objects in a communication system according to an embodiment. FIG. 5 is described below assuming that the sensing matrix is applied to a pair of frames. However, the same method may be applied in the case that the measurement matrix is applied to more than two frames.

After the video decoder 205 determines that the criterion value computed from the inter-frame difference of the sets of measurements is above the first threshold, the video decoder 205 may reconstruct a video representation of the moving objects from the inter-frame difference in order to verify the presence and examine the properties of moving objects. However, it is noted that the method of FIG. 5 may be used without performing the detection of steps S425, S430 and S440 of the method of FIG. 4. For example, after receiving the first and second sets of measurements, the video decoder 205 may compute the inter-frame difference as in step S420 and then reconstruct a video representation of the moving objects from the inter-frame difference according to FIG. 5 without computing a criterion value for the measurements inter-frame difference and comparing this criterion value to the first threshold.

In step S505, the video decoder 205 obtains the sensing matrix that was applied to the pixel vectors representing the first and second frames. As indicated above, the sensing matrix for the frames (e.g., first frame and second frame) in each pair has the same assigned values. The sensing matrix may be previously known by the video decoder 205, and thus may be obtained from an internal memory of the processing unit 103, or generated at run time according to a predetermined formula.

In S510, the video decoder 205 reconstructs a difference between the first frame and the second frame based on the first set of measurements and the second set of measurements as well as the obtained sensing matrix. For example, the video decoder 205 reconstructs the difference between pairs of frames −dₖ=x₂ₖ₊₁−x₂ₖ, k=0, 1, . . . . The parameter x refers to the respective frame. In one particular example (e.g., k=0), the difference is obtained between frame x₁ and frame x₀. The video decoder 205 computes the difference dₖ=x₂ₖ₊₁−x₂ₖ using the measurements and the sensing matrix based on the following minimization equation:

min∥f(dₖ)∥₁, subject to φₖdₖ=y₂ₖ₊₁−y₂ₖ Eq. 2:

The parameter φₖ is the sensing matrix described above, and the parameters y₂ₖ₊₁ and y₂ₖ are the first and second set of measurements for each value of K.

Function f( ) may be chosen to be the total variation (TV) as provided below.

f(dₖ)=TV(dₖ)

$$TV ( x ) = {\sum }_{i , j} \vert {x}_{ij + 1} - {x}_{ij} \vert + \vert {x}_{i + 1 j} - {x}_{ij} \vert \qquad Eq . 3$$

xᵢⱼ is the value at pixel location i, j in a frame

However, the embodiments encompass other choices for the function f( ) such as wavelet transform, tight frame transform etc.

The video decoder 205 may include a TV minimization solver in order to compute the above equation resulting in the difference dₖ=x₂ₖ₊₁−x₂ₖ.

In step S515 the video of the moving is optionally directed to the display 206 and presented to an operator. Viewing the moving objects alone may make the evaluation by the operator much easier than viewing it as part of the whole scene because it eliminates the distraction of the background. This is particularly true at lower bit rate, where due to coding artifacts the background may appear as “flickering.”

In step S520, the video decoder 205 compares the reconstructed difference to a second threshold. If the absolute value of the difference at a pixel is above the second threshold, the pixel is considered to be part of moving objects. Additional measures may be added in order to improve the reliability of the detection, e.g. smoothing by median filtering in order to improve contiguity. Otherwise, if the absolute value of the difference at the pixel is below the second threshold, the pixel is considered to be part of the background. If the video decoder 205 determines that the reconstructed difference of all pixels is equal to or below the second threshold, the process may continue to step S410 in FIG. 4. Alternatively, the process may proceed to step S570 in order to obtain an additional pair of measurements (e.g., another first set of measurements and second set of measurement that were generated from the same sensing matrix), and then proceed back to step S505. However, if some pixels in the reconstructed difference are above the second threshold, the pair of frames is considered to contain moving objects.

In step S530, the video decoder 205 extracts the moving objects, by identifying contiguous regions of pixels above the second threshold.

In step S531, each extracted video object may optionally be analyzed in order to determine if the extracted video object is of interest. The analysis may include determination of properties such as position, size, speed and direction of movement and a classification to some categories, e.g. “a person” or “a bus”. The techniques for performing such an analysis are well known in the art, however, the fact that the objects have been extracted from the background makes these technique more effective. In step S532, the extracted objects of interest are sent to the display 206 for evaluation.

The determination that a moving object is of interest often depends not only on the properties of the object itself but also on its position with respect to the background. For example, a fast moving vehicle on the road may be of less interest than the same fast moving vehicle on a side walk. In principle, when we have two or more of sets of measurements obtained with the same sensing matrix, the background can be reconstructed from the average of those sets of measurements. However, if the number of measurements in each set is small, it may not be sufficient to faithfully reconstruct the background with all its detail.

FIG. 6 illustrates a method of detecting motion of an object in a communication system according to another embodiment which allows the reconstruction of the background as well.

The method in FIG. 6 relates to obtaining the background of the video data and detecting moving objects in relation to the obtained background. In order to obtain sufficient information to create the background of the acquired video data, the video decoder 202 obtains pairs of measurements over a certain period of time. The period of time may be predefined or variable depending on the application. In other words, the accumulated measurements over the period of time can be used to reconstruct high quality images of still scenes such as background.

In step S610, the video decoder 205 obtains sets of measurements for the frames over the period of time. For example, the sets of measurements may include a number of pairs (e.g., 50 pairs), where each pair includes a first set of measurements and second set of measurements. However, the number of pairs may be any integer greater or equal to one. As described above, the first and second sets of measurements were generated using the same sensing matrix.

In step S620, the video decoder 205 obtains sensing matrices that were applied to the pixel vectors representing the frames of the pairs. The sensing matrices may be previously known by the video decoder 205, and thus may be obtained from an internal memory of the processing unit 103, or generated at run time according to a predefined formula.

In step S630, the video decoder 205 reconstructs pixel values for a scene that is common to each pair (e.g., the background) and a pixel difference value for each pair. The reconstructed pixel values for the common scene is the background of the video data. The video decoder 205 performs such a reconstruction based on the following equation:

y₂ₖ=φₖx₂ₖ

y₂ₖ₊₁=φ₅x₂ₖ₊₁ Eq. 4:
k=0, 1, . . . , K−1

As indicated above, the parameter y is the set of measurements, x is the pixel vector having pixel values for a respective frame, and k is any integer greater than or equal to zero, and φ is the sensing matrix as previously described.

Eq. 4 may be rearranged as follows:

y₂ₖ+y₂ₖ₊₁=φₖx₂ₖ+φₖx₂ₖ₊₁=φₖ(x₂ₖ+X₂ₖ₊₁), k=0, 1, . . . , K−1 Eq. 5:

Each of x₂ₖ+X₂ₖ₊₁ may be considered to be a common scene plus differences as follows:

$${x}_{0} + {x}_{1} = 2 c + {e}_{0} , \\ {x}_{2} + {x}_{3} = 2 c + {e}_{1} , \\ … \\ {x}_{2 K - 2} + {x}_{2 K - 1} = 2 c + {e}_{K - 1} \qquad Eq . 6$$

The video decoder 205 reconstructs the common scene c (that is common to each pair in the time interval), and a difference value for each pair eₖ based on the sets of measurements and the obtained sensing matrix using the following minimization problem:

$$min ( TV ( c ) + {\sum }_{k = 1}^{K - 1} TV ( {e}_{k} ) ) \\ subject to \\ {y}_{2 k} + {y}_{2 k + 1} = 2 {φ}_{k} c + {φ}_{e} {e}_{k} , k = 0 , 1 , … , K - 1 \qquad Eq . 7$$

The function TV was previously explained above. The parameter c refers to the common scene and the parameter eₖ refers to the difference value for each pair for k=0, 1, . . . , K−1. The other parameters in Eq. 7 were previously described. The video decoder 205 may include a TV minimization solver in order to compute the above equation.

In step S640, the video decoder 205 displays the video data on the display 206 based on the computed common scene and the difference values. The common scene c represents the background, and the differences eₖ represent moving objects. The displayed video data may indicate the movement of the objects in relation to the background, where a user may be able to get a better understanding of the type of movement.

In step S640, based on the displayed video data, objects may be detected. If at least one object is detected, the video decoder 205 may transmit information indicating that at least one object has been detected. Alternatively, if movement is not detected, the process may proceed back to step S610 in order to collect additional measurements over the period of time.

As a result, the embodiments provide a relatively simpler encoding scheme, a reduced data rate to be transmitted from the camera assemblies, reliable detection of anomalies/foreign objects with low data rate, and high quality video for still scene using accumulated data over a period of time. Further, the embodiments provide relatively low complexity for the camera assemblies, low power consumption for wireless cameras and the same transmitted measurements can be used to reconstruct high quality video of still scenes.

Variations of the example embodiments are not to be regarded as a departure from the spirit and scope of the example embodiments, and all such variations as would be apparent to one skilled in the art are intended to be included within the scope of this disclosure.

What is claimed:

1. A method for encoding data in a communication system, the method comprising:
receiving, by an encoder, video data including a plurality of frames, each frame being represented by a pixel vector including a number of pixel values; and
generating, by the encoder, sets of measurements representing the plurality of frames, each set of measurements representing a different frame of the plurality of frames,
wherein the generating step generates the sets of measurements by applying sensing matrices to the pixel vectors, and a same sensing matrix is used for at least two sets of measurements.

2. The method of claim 1, wherein the sets of measurements include pairs of sets of measurements, each pair includes a first set of measurements representing a first frame and a second set of measurements representing a second frame.

3. The method of claim 2, wherein, for each pair, the generating step generates the first set of measurements and the second set of measurements using a same sensing matrix, and different sensing matrices are used for at least two pairs.

4. The method of claim 2, wherein the first frame and the second frame are consecutive frames in the plurality of frames.

5. The method of claim 1, wherein the generating step generates groups of sets of measurements by applying sensing matrices to pixel vectors, wherein each group includes at least two sets of measurements, wherein a same sensing matrix is used to generate each set of measurement in the same group, and the sensing matrices used in at least two groups are different.

6. A method for detecting at least one moving object in a communication system, the method comprising:
receiving, by a decoder, sets of measurements, each set of measurements representing a different frame of video data;
obtaining, by the decoder, inter-frame difference among the sets of measurements; and
detecting, by the decoder, the at least one moving object in the video data by processing the inter-frame difference between the sets of measurements.

7. The method of claim 6, wherein the receiving step receives a pair of measurements, the pair including a first set of measurements representing a first frame of video data and a second set of measurements representing a second frame of video data, and the obtaining step obtains the difference between the first set of measurements and the second set of measurements as the inter-frame difference.

8. The method of claim of 6, wherein the detecting step further includes:
computing, by the decoder, a criterion value based on the inter-frame difference among the sets of measurements; and
detecting the at least one moving object in the video data if the criterion value is above a first threshold.

9. The method of claim of 6, wherein the detecting step further includes:
obtaining, by the decoder, a sensing matrix that was applied to pixel vectors representing the frames at an encoder, the sensing matrix having same assigned values for each of the frames;
reconstructing, by the decoder, the inter-frame difference among the frames based on the obtained inter-frame difference among the sets of measurements and the sensing matrix; and
detecting the at least one moving object if at least one pixel in the reconstructed difference among the frames have a magnitude above a second threshold.

10. The method of claim 9, wherein at least one moving object is extracted by identifying contiguous regions of pixels in the reconstructed difference which have a magnitude above the second threshold.

11. The method of claim 6, further comprising:
obtaining, by the decoder, groups of sets of measurements for frames in the video data over a period of time;
obtaining, by the decoder, sensing matrices that were applied to pixel vectors representing the frames at the encoder, each group corresponding to a different sensing matrix;
reconstructing, by the decoder, pixel values for a scene that is common to each group and a pixel difference value for each group based on the groups of measurements and the obtained sensing matrices, the reconstructed pixel values for the scene that is common to each group being background of the video data; and
detecting the at least one moving object based on the reconstructed pixel values and the pixel difference value for each pair.

12. The method of claim 11, further comprising:
displaying the video data based on the reconstructed pixel values and the pixel difference value for each group; and
detecting the at least one moving object based on displayed video data.

13. An apparatus for encoding data in a communication system, the apparatus comprising:
an encoder configured to receive video data including a plurality of frames, each frame being represented by a pixel vector including a number of pixel values,
the encoder configured to generate sets of measurements representing the plurality of frames, each set of measurements representing a different frame of the plurality of frames,
wherein the encoder generates the sets of measurements by applying sensing matrices to the pixel vectors, and a same sensing matrix is used for at least two sets of measurements.

14. The apparatus of claim 13, wherein the sets of measurements include pairs of sets of measurements, each pair includes a first set of measurements representing a first frame and a second set of measurements representing a second frame.

15. The apparatus of claim 14, wherein, for each pair, the encoder is configured to generate the first set of measurements and the second set of measurements using a same sensing matrix, and different sensing matrices are used for at least two pairs.

16. An apparatus for detecting at least one moving object in a communication system, the apparatus comprising:
a decoder configured to receive sets of measurements, each set of measurements representing a different frame of video data,
the decoder configured to obtain inter-frame difference among the sets of measurements,
the decoder configured to detect the at least one moving object in the video data by processing the inter-frame difference between the sets of measurements.

17. The apparatus of claim 16, wherein the decoder is configured to receive a pair of measurements, the pair including a first set of measurements representing a first frame of video data and a second set of measurements representing a second frame of video data, and the decoder is configured to obtain the difference between the first set of measurements and the second set of measurements as the inter-frame difference.

18. The apparatus of claim of 16, wherein
the decoder is configured to compute a criterion value based on the inter-frame difference among the sets of measurements,
the decoder is configured to detect the at least one moving object in the video data if the criterion value is above a first threshold.

19. The method of claim of 16, wherein
the decoder is configured to obtain a sensing matrix that was applied to pixel vectors representing the frames at an encoder, the sensing matrix having same assigned values for each of the frames,
the decoder is configured to reconstruct the inter-frame difference among the frames based on the obtained inter-frame difference among the sets of measurements and the sensing matrix,
the decoder is configured to detect the at least one moving object if at least one pixel in the reconstructed difference among the frames have a magnitude above a second threshold.

20. The apparatus of claim 16, wherein
the decoder is configured to obtain groups of sets of measurements for frames in the video data over a period of time,
the decoder is configured to obtain sensing matrices that were applied to pixel vectors representing the frames at the encoder, each group corresponding to a different sensing matrix,
the decoder is configured to reconstruct pixel values for a scene that is common to each group and a pixel difference value for each group based on the groups of measurements and the obtained sensing matrices, the reconstructed pixel values for the scene that is common to each group being background of the video data, wherein the at least one moving object is detected based on the reconstructed pixel values and the pixel difference value for each pair.
